(19) United States
(12) Patent Application Publication
(10) Pub. No.: US 2016/0297714 A1
(43) Pub. Date: Oct. 13, 2016

(54) MOLYBDENUM CARBIDE / CARBON COMPOSITE AND MANUFACTURING METHOD

(71) Applicants: CERN - EUROPEAN ORGANIZATION FOR NUCLEAR RESEARCH, Génèva 23 (CH); BREVETTI BIZZ S.R.L., San Bonifacio (VR) (IT)

(72) Inventors: Alessandro BERTARELLI, Thoiry (FR); Stefano BIZZARRO, (US)

(73) Assignees: CERN - EUROPEAN ORGANIZATION FOR NUCLEAR RESEARCH, Génèva 23 (CH); BREVETTI BIZZ S.R.L., San Bonifacio (IT)

(21) Appl. No.: 15/033,505

(22) PCT Filed: Oct. 31, 2013
(86) PCT No.: PCT/EP2013/072818

§ 371 Date: Apr. 29, 2016

(51) Int. Cl. C04B 35/76; G21F 1/12; B28B 3/02; C04B 35/645; C04B 41/51

(52) U.S. Cl. CPC C04B 35/76; C04B 35/6455; C04B 41/5133; B28B 3/025; G21F 1/125; C04B 2235/425; C04B 2235/3839; C04B 2235/5248; C04B 2235/526; C04B 2235/404; C04B 2235/3826; C04B 2235/66; C04B 2235/6582; C04B 2237/403; C04B 2237/706

(57) ABSTRACT

A composite material comprising molybdenum carbide, graphite and carbon fibers combines a very high thermal conductivity with a low coefficient of thermal extension, high service temperature, good mechanical properties and high electrical conductivity. These materials may be obtained from high-temperature sintering of variable proportions of molybdenum powders and ceramic materials such as graphite, carbon fibers, silicon, silicon carbide, or tungsten.

### FIELD OF THE INVENTION

The invention relates to a molybdenum carbide/carbon composite, such as for applications for beam intercepting devices in high energy physics applications, and to a method for manufacturing the composite.

### BACKGROUND OF THE INVENTION AND STATE OF THE ART

The introduction in recent years of new, extremely energetic particle accelerators such as the Large Hadron Collider (LHC) at CERN (European Organization for Nuclear Research) brought about the need for advanced cleaning and protection systems in order to safely increase the energy and intensity of particle beams to unprecedented levels.

A crucial component of the cleaning and protection system are the collimators, which are designed to intercept and absorb the intense particle losses unavoidably induced in accelerators, and to shield other components from the catastrophic consequences of beam orbit errors.

Furthermore, recent ambitious programs for the development of accelerator facilities, aimed at the massive production of elusive particles such as neutrinos or muons, rely on target systems submitted to the impact of proton beams at extraordinary intensities (impact power up to 5 MW).

One key element to obtain next-generation beam intercepting devices (collimators, targets, dumps, absorbers, spoilers, windows, etc.) meeting these requirements lies in the development and use of novel advanced materials as no existing metal-based or carbon-based material possesses the combination of physical, thermal, electrical and mechanical properties which are required to withstand such extreme working conditions.

Special materials and composites have been developed to withstand the impact of high energy and high intensity particle beams to avoid the formation of shock waves, or at least mitigate their effects. Graphite materials, in particular carbon-fiber reinforced carbon (C/C), are among the most effective materials presently used, particularly because of their very high thermal shock resistance and low atomic number. However, their use is partly impaired by their low electrical conductivity, which leads to high RF impedance. In certain cases, this may cause serious beam instabilities, particularly at very high beam intensities, and will automatically limit the performance reach of high intensity accelerators. In addition, experimental findings suggest that C/C thermal-mechanical properties can be severely degraded by the radiation damage accumulated over several years of operation and high particle fluxes.

High-Z metals such as copper and molybdenum possess very good electrical properties. However, the high density adversely affects their thermal stability and accident robustness.

Copper-diamond composite materials exhibit a balanced compromise between electrical conductivity, density, and thermal conductivity. However, their melting point is in the range of approximately 1.000° C., and hence too low for many practical applications.

Molybdenum-graphite composites were explored in the 1960s and 1970s for high-temperature aerospace and nuclear applications, e.g. cf. Y. Harada “Graphite-Metal Carbide Composites”, NASA contractor report CR-507, June 1966. However, these materials were relatively brittle and characterized by low mechanical strength. Furthermore, tests were carried out on small specimens at a laboratory scale only. No significant further developments seem to have occurred ever since.

What is required is a new composite material that avoids the disadvantages of the prior art and meets the demanding requirements for collimators and other applications, as well as a corresponding manufacturing method.

### OVERVIEW OF THE PRESENT INVENTION

This objective is achieved with a composite material according to independent claim 1, and a corresponding manufacturing method according to independent claim 17. The dependent claims relate to preferred embodiments.

A composite material according to the present invention comprises molybdenum carbide, graphite and carbon fibers.

The inventors found that a molybdenum carbide/carbon composite comprising carbon fibers allows to combine the desirable properties of metals (such as large electrical conductivity and high fracture toughness) with high thermal conductivity, low density, and a low coefficient of thermal expansion. This combination of properties makes the new family of materials ideally suited for applications in beam intercepting devices, such as beam jaws in collimators, but also for a large number of other applications with similar requirements, such as for thermal management applications for microelectronics, braking discs for high-end sports cars, or materials for plasma-facing components in nuclear fusion reactors.

The inventors found that the addition of carbon fibers substantially improves the thermal conductivity as well as the mechanical strength and fracture toughness. The addition of carbon fibers along with molybdenum carbides may also enhance and accelerate the graphitization process in the carbonaceous phases. This is an important advantage over conventional molybdenum carbide composites.

In a preferred embodiment, said composite material may consist of only molybdenum carbide, graphite and carbon fibers.

The composite material may be a metal matrix composite and/or ceramic matrix composite.

The molybdenum carbide may comprise Mo₂C and/or other molybdenum carbide phases, such as MoC.

In a preferred embodiment, said carbon fibers are pitch-based carbon fibers.

As opposed to the more conventional polyacrylonitrile (PAN) carbon fibers that comprise straight-chain eliphatic polymers, the pitch-based carbon fibers comprise polycyclic aromatic hydrocarbons. The inventors found that the well-aligned crystal domains in the latter component lead to a significantly higher thermal conductivity.

Said pitch-based fibers may be obtained from a heat treatment of re-fined coal tar or petrol tar.

In a preferred embodiment, said carbon fibers are mesophase pitch-based fibers.

These fibers may be obtained by spinning coal tar or petrol tar that has been heated to an all-flow state. The mesophase provides for an alignment of the fibers in the liquid crystal, which makes them well-suited for subsequent spinning.

In a preferred embodiment, at least a part of said carbon fibers are long fibers with a length no shorter than 2 mm and/or no longer than 6 mm.

Preferably, said long fibers are no longer than 3 mm.

These fibers may be obtained by chopping longer carbon fibers.

Alternatively or additionally, at least a part of said carbon fibers may be short fibers with a length no smaller than 0.05 mm and/or no greater than 1 mm.

Preferably, said short fibers are no longer than 0.3 mm.

The short fibers may be obtained by milling longer fibers.

The inventors found that very good results can be achieved with a combination of both long fibers and short fibers, wherein the long fibers have a length no smaller than 2 mm and/or no greater than 6 mm, and wherein the short fibers have length no smaller than 0.05 mm and/or no greater than 1 mm, preferably no greater than 0.3 mm.

Long fibers contribute to increase thermal conductivity, mechanical strength and fracture toughness, whereas short fibers can be mainly used as fillers to improve material compaction while contributing to excellent thermal conductivity in a quasi-isotropic arrangement.

Preferably, long fibers and short fibers are present in said molybdenum carbide/carbon composite at approximately equal volume percentages.

A ratio of the volume percentages of the short fibers and the long fibers may be no smaller than 0.8, and/or no larger than 1.2.

In a preferred embodiment, said composite material comprises at least 1% by volume of said carbon fibers, preferably at least 10% by volume of said carbon fibers, and particularly at least 20%.

Further, the composite material according to the present invention may comprise at most 40% by volume of carbon fibers, and preferably at most 30% by volume of carbon fibers.

In a preferred embodiment, the composite material further comprises additional refractory metals, in particular tungsten.

The inventors found that small amounts of finely dispersed refractory metals such as tungsten may serve to increase the mechanical strength of the composite material.

In an embodiment of the invention, the composite material comprises at most 10% by volume of tungsten powder, and preferably at most 1.5% by volume of tungsten powder.

Alternatively or additionally, the composite material according to the present invention may further comprise refractory ceramic materials, in particular silicon carbide.

In a preferred embodiment, the composite material comprises at most 10% by volume of silicon carbide, and preferably at most 5% by volume.

Alternatively or additionally, the composite material according to the present invention may further comprise silicon.

In a preferred embodiment, the composite material comprises at most 10% by volume of silicon, and preferably at most 5% by volume.

The inventors found that silicon reacts with carbon forming silicon carbide.

The inventors also found that silicon carbide may serve to maintain the thermal conductivity of the composite material. At the same time, silicon carbide, as well as other refractory ceramics, increases oxidation resistance thanks to its inertness, and may hence prevent the composite material from degradation in strongly oxidizing environments.

The composite material according to the present invention may comprise an outer layer of refractory ceramics, particularly silicon carbide. Said outer layer may be formed on at least one of the surface sides of said composite material.

By providing inert refractory ceramics and particularly silicon carbide as an outer layer, the composite material can be protected effectively against oxidation that might otherwise occur at high temperatures through contact with the oxidizing environment.

In a preferred embodiment, said composite material has an outer layer comprising or consisting of molybdenum, in particular pure (elemental) molybdenum.

The inventors found that an outer layer of pure molybdenum serves to further enhance the electrical conductivity of the composite material from 1 MS/m to approximately 19 MS/m. This allows to effectively suppress the beam instabilities that could result from a high RF impedance.

In a preferred embodiment, said outer molybdenum layer has a thickness of at least 0.1 mm, preferably at least 0.5 mm.

The invention further relates to a method for manufacturing a molybdenum carbide/carbon composite, comprising the steps of providing a mixture comprising molybdenum powder, graphite particles and carbon fibers, and sintering by rapid hot-pressing said mixture, wherein said rapid hot-pressing comprises a liquid-phase sintering in a sintering chamber of a sintering furnace at a temperature of at least 2,500° C., preferably at least 2,600° C.

The inventors found that liquid-phase sintering a mixture of molybdenum powder, graphite particles and carbon fibers at a temperature of at least 2,500° C. allows providing the new family of composite materials according to the present invention, with a combination of very high thermal conductivity, low coefficient of thermal expansion, high service temperature, good mechanical strength and electrical conductivity.

The extensive graphitization during the liquid phase sintering of carbon at temperatures in excess of 2500° C. ensures excellent thermal properties and good mechanical strength. The high mobility of carbon atoms favors a solid-state reaction between molybdenum and graphite, which generates Mo₂C and possibly other molybdenum carbide phases.

Preferably, said liquid-phase sintering is performed at a pressure of at least 30 MPa.

In particular, said liquid-phase sintering may be performed at a pressure of at least 35 MPa, or at least 40 MPa.

Said pressure may be a mechanical pressure imposed on the mixture, such as by punches or pistons.

The combination of high temperatures and high pressure during the liquid-phase sintering provides for excellent material properties.

In a preferred embodiment, the sintering furnace is evacuated for said rapid hot-pressing preferably to a pressure of no more than 10⁻² mbar, in particular no more than 10⁻⁴ mbar.

In a preferred embodiment, said rapid hot-pressing comprises a venting step of introducing a reducing gas into said sintering furnace, in particular a gas mixture of N₂ and H₂.

Venting allows the removal of oxygen from the sintering furnace, and hence prevents an unwanted oxidation during the rapid hot-pressing process.

In a preferred embodiment, said rapid hot-pressing comprises alternating steps of venting by introducing a reducing gas into said sintering furnace, and evacuating said sintering furnace.

Preferably said sintering furnace is evacuated to a pressure of no more than 10⁻² mbar, in particular no more than 10⁻⁴ mbar.

In a preferred embodiment, said rapid hot-pressing comprises heating said mixture by means of a direct current flow.

In a preferred embodiment, said direct current flow may be pulsed.

The inventors have achieved particularly good results with a configuration in which the sintering mould that is placed in the sintering furnace is equipped with electrodes that comprise a gold coating. The gold coating increases the homogeneity of the current flow through the mould and preform/powder.

In a preferred embodiment, said rapid hot-pressing comprises a step of monitoring a temperature in said sintering furnace or sintering chamber, and adjusting a heating rate in said sintering chamber in accordance with said monitored temperature.

Monitoring and controlling a heating rate in said sintering chamber allows achieving a highly reproducible temperature cycle and manufacturing process. In particular, the current flow through the sintering mould may be controlled in real-time in accordance with the temperature measured by means of the temperature monitoring means, such as a pyrometer or other high temperature probes.

In a preferred embodiment, said method comprises a step of cold-pressing said mixture prior to the rapid hot-pressing.

The cold-pressing may be preferably performed at a pressure of at least 10 MPa, and in particular at least 15 MPa.

Said pressure may again be a mechanical pressure provided by pressure actuation means, such as punches or pistons.

In a preferred embodiment, said mixture of components comprises at least 5% by volume of molybdenum powder, and in particular at least 8% by volume of molybdenum powder.

Said mixture may comprise at most 25% by volume of molybdenum powder, and preferably at most 20% by volume of molybdenum powder.

In a preferred embodiment, said molybdenum powder has particle sizes no smaller than 1 μm, and/or no larger than 50 μm.

In a preferred embodiment, said mixture comprises at least 30% by volume of graphite particles, and preferably at least 40% by volume of graphite particles.

In a preferred embodiment, said graphite particles are natural graphite flakes.

In a preferred embodiment, said mixture comprises no more than 85% by volume of natural graphite flakes, and preferably no more than 75% by volume of natural graphite flakes.

The inventors have achieved good results with natural graphite flakes having a platelet size of at least 20 μm, and/or no more than 400 μm.

Said mixture may comprise carbon fibers, in particular pitch-based carbon fibers.

As described above, the carbon fibers may serve as a catalyst for the graphitization, and increase the thermal conductivity, mechanical strength and fracture toughness.

In a preferred embodiment, at least a part of said carbon fibers are fibers with a length no smaller than 2 mm, and/or no larger than 6 mm.

Alternatively or additionally, at least a part of said carbon fibers are short carbon fibers with a length no shorter than 0.05 mm, and/or no larger than 1 mm, preferably no larger than 0.3 mm.

In a preferred embodiment, said carbon fibers comprise both long carbon fibers and short carbon fibers, wherein the long fibers have a length no shorter than 2 mm and/or no longer than 6 mm, and wherein the short fibers have a length no shorter than 0.05 mm and/or no greater than 1 mm, preferably no longer than 0.3 mm.

In a preferred embodiment, a ratio of volume percentages of said short fibers and long fibers in said mixture is no smaller than 0.8, and/or no larger than 1.2.

In a preferred embodiment, said mixture comprises at least 1% by volume of said carbon fibers.

Preferably, said mixture comprises at least 10% by volume of said carbon fibers, and in particular at least 20%.

In a preferred embodiment said mixture comprises at most 40% by volume of carbon fibers, and in particular at most 30% by volume of carbon fibers.

Said mixture may also comprise additional refractory metals, particularly tungsten powder.

In a preferred embodiment, said mixture comprises at most 10% by volume of tungsten, and in particular at most 1.5% by volume of tungsten.

Said tungsten powder may have particle sizes no smaller than 0.5 μm, and/or no larger than 6 μm.

As described above with reference to the composite material, a fine dispersion of additional refractory metals and particularly tungsten powder allows to increase the mechanical strength of the material.

In a preferred embodiment, said mixture comprises refractory ceramics, in particular silicon carbide powder.

Said mixture may comprise at most 10% by volume of silicon carbide powder, and preferably at most 5% by volume.

Said silicon carbide powder may have particle sizes no smaller than 1 μm, and/or no larger than 50 μm.

Alternatively or additionally, said mixture may also comprise silicon powder.

Said mixture may comprise at most 10% by volume of silicon powder, and preferably at most 5% by volume of silicon powder.

Said silicon powder may have particle sizes no smaller than 1 μm, and/or no larger than 50 μm.

As described above, refractory ceramics and particularly silicon carbide (as such or produced by the reaction of silicon with carbon) may serve to resist oxidation and to prevent high temperature degradation of the composite material. They also serve as a thermal conductor.

Said method may further comprise a step of providing said silicon carbide in a boundary region of said mixture.

When the silicon carbide is provided in a boundary region of the mould, it will form an outer layer in the sintered composite material, thereby effectively preventing against oxidation.

In a preferred embodiment, the method comprises a step of cladding said molybdenum carbide/carbon composite with an outer layer comprising molybdenum, in particular pure (elemental) molybdenum.

Molybdenum in the outer layer serves to enhance the electrical conductivity of the composite material.

Said outer layer of molybdenum may be provided at a thickness of at least 0.1 mm, preferably at least 0.5 mm.

In a preferred embodiment, said thickness of said outer layer mounts to at most 2 mm, in particular at most 1.5 mm.

### DESCRIPTION OF PREFERRED EMBODIMENTS

The features and numerous advantages of the composite material and manufacturing method according to the present invention will be best understood from a detailed description of preferred embodiments with reference to the accompanying Figures, in which:

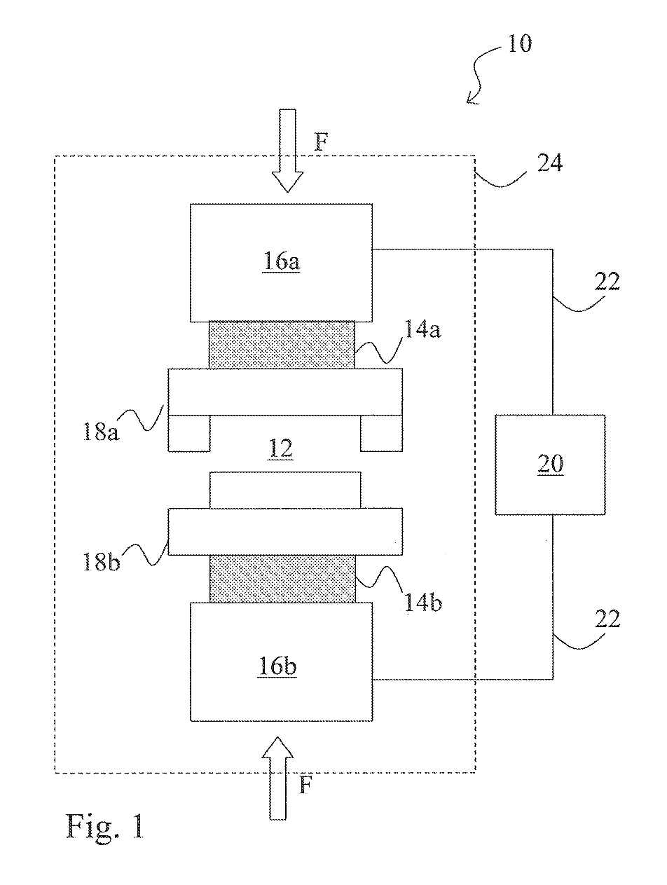

FIG. 1 is a schematic illustration of a sintering furnace in which a method according to an embodiment of the present invention may be implemented;

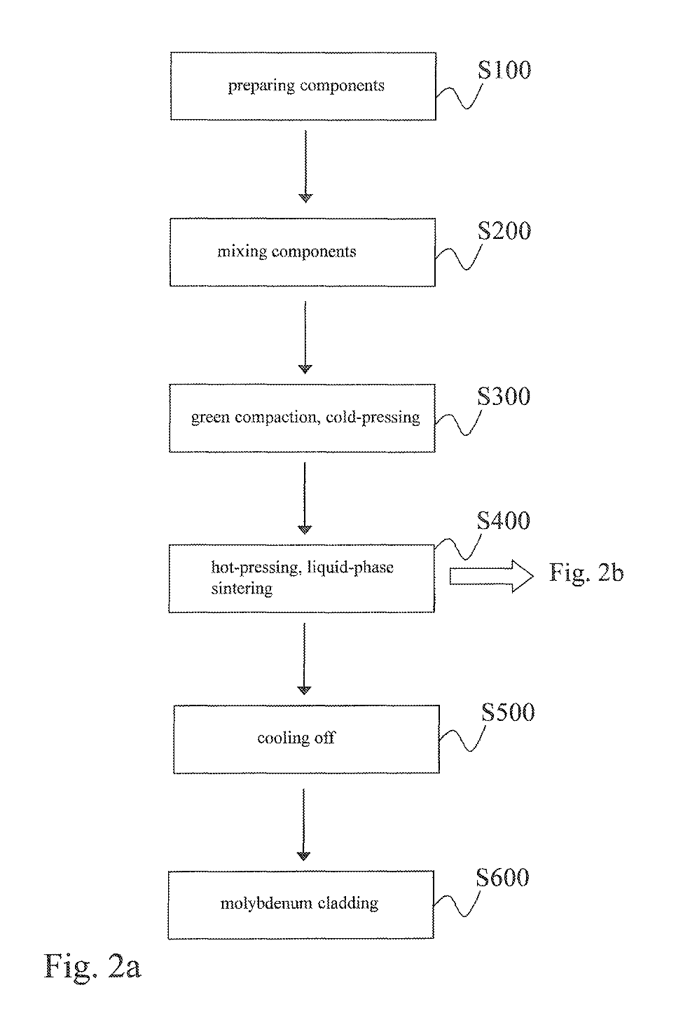

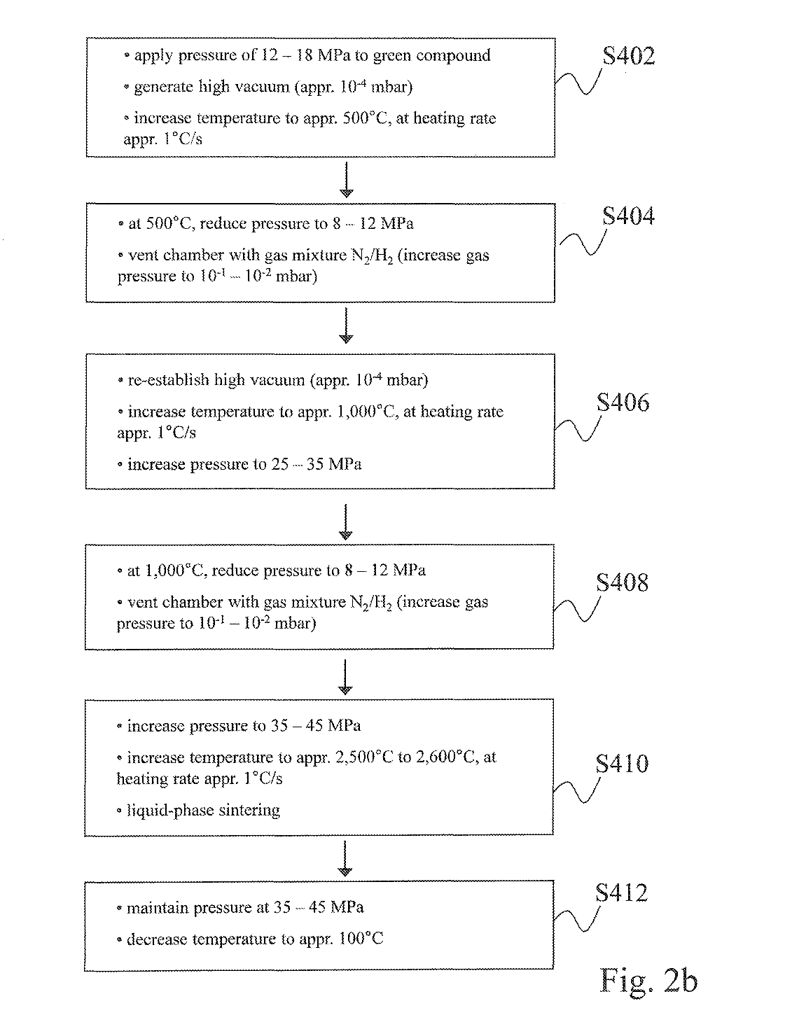

FIG. 2a is a flow diagram of a method for manufacturing a molybdenum carbide/carbon composite according to an embodiment of the present invention; and

FIG. 2b is a flow diagram showing the sub steps of the hot-pressing according to an embodiment of the present invention;

A method for manufacturing the new family of molybdenum carbide/carbon composite materials according to the present invention by means of high-temperature sintering and rapid hot-pressing will now be described with reference to FIGS. 1 and 2.

FIG. 1 is a schematic illustration of a sintering furnace 10. The sintering furnace 10 comprises a central sintering chamber 12 in which the components are provided as a preform or powder in moulds 18a, 18b, and in which the composite material is formed by hot-pressing said preform, as will be described in further detail below. The female mould 18a and male mould 18b together define a tight sintering chamber 12 therein between. A plurality of graphite punches 14a, 14b surround the sintering chamber 12 and moulds 18a, 18b so to exert a mechanical pressure on the mould and preform. The amount of pressure exerted on the preform through the graphite punches 14a, 14b can be adjusted and controlled by means of corresponding force actuators 16a, 16b.

The schematic diagram of FIG. 1 shows only two graphite punches 14a, 14b and two corresponding force actuators 16a, 16b. However, it is to be understood that the sintering apparatus 10 may comprise a larger number of graphite punches and corresponding force actuators, depending on the shape of the mould and the pressure that shall be exerted.

The sintering furnace 10 is provided with a vacuum chamber 24 that encloses the sintering chamber 12, moulds 18a, 18b, punches 14a, 14b and force actuators 16a, 16b. The vacuum chamber 24 may be evacuated to a high vacuum by means of evacuation means (not shown), and may be vented by means of venting means (not shown).

The sintering chamber 12 and the preform contained therein is heated by means of a pulsed or continuous DC current that is supplied from a DC current source 20 to the sintering chamber 12 via cable connections 22, the force actuator 16a, 16b, graphite punches 14a, 14b, and graphite dies 18a, 18b. The current generates heat by the Joule effect in the elements surrounding the sintering chamber 12, and in the mould and preform.

Sintering techniques such as rapid hot-pressing (RHP), spark plasma sintering (SPS), and liquid infiltration that may be employed in the context of the present invention are generally well-known in the art, and hence a detailed description of these techniques is omitted. Reference is instead made to the review article “Electric current activated/assisted sintering (ECAS): a review of patents 1906 to 2008” by Salvatore Grasso et al., Science and Technology of Advanced Materials 10 (2009) 053001.

However, in the context of the present invention some useful improvements over the conventional sintering apparatus have been made. For instance, the electrodes that connect the punches 14a, 14b to the moulds 18a, 18b have been provided with gold coating to increase the homogeneity of the current flow through the graphite punches 14a, 14b and the preform. In addition, temperature probes such as pyrometers (not shown in FIG. 1) have been provided to adjust in real-time the current flow and temperature in the sintering chamber 12. These measures allow reaching in a safe and controlled way processing temperatures which may well exceed 2.500° C.

The sintering furnace 10 further comprises evacuation means (not shown in FIG. 1) to evacuate the vacuum chamber 24 to a high vacuum, down to 10⁻⁴ mbar or less. The sintering furnace 10 also comprises venting means (not shown in FIG. 1) adapted to introduce a reducing gas, such as a mixture of N₂H₂, into the sintering furnace 10.

Processing temperatures in excess of 2.500 ° C. under mechanical pressure and high vacuum have, to the best of the inventor's knowledge, never before been reached for a real-scale production.

Production of molybdenum carbide/carbon composite material according to an embodiment of the present invention within the sintering apparatus 10 will now be described with reference to the flow diagrams of FIGS. 2a and 2b.

In a first step S100, the components are prepared and mixed. The components may comprise molybdenum fine powders with a particle size ranging from 1 to 50 μm, graphite particles and particularly natural graphite flakes with platelet sizes ranging from 20 to 400 μm, as well as mesophase-pitch based carbon fibers with a length between 0.05 to 6 mm.

An exemplary composition may comprise between 5 and 25% in volume of molybdenum powders, between 30 and 85% in volume of natural graphite flakes and between 1 and 40% in volume of mesophase-pitch based carbon short fibers. For instance, a preferred embodiment may comprise 20% in volume of molybdenum powders, 40% in volume of natural graphite flakes and 40% in volume of mesophase pitch-based carbon fibers. The carbon fibers may be a mixture or blend of 20% by volume of relatively longer fibers in the length range of between 2 mm and 6 mm, and 20% by volume of relatively shorter fibers in the length range of between 0.05 mm and 1 mm.

Mesophase-pitch based carbon fibers with these dimensions are readily available from Mitsubishi Plastics, Inc., among other sources. Details on the properties of these fibers can be found in the overview article by Y. Arai, “Structure and Properties of Pitch-Based Carbon Fibers”; Nippon Steel Technical Report Nr. 59, October 1993; page 65 et seqq.

The inventors found that the carbon fibers along with molybdenum carbide may serve as a catalyst that assists in the graphitization process, and at the same time enhance the thermal conductivity, mechanical strength and fracture toughness.

Apart from the components described above, the preform may comprise between 1% and 10% in volume of tungsten powders, preferably with particle sizes ranging from 0.5 μm to 6 μm. The inventors found that adding a fine dispersion of tungsten powder serves to enhance the mechanical strength.

The mixture may also comprise between 1% and 10% in volume of silicon carbide powders, preferably with particle sizes ranging from 1 μm to 50 μm, and/or between 1% and 10% in volume of silicon powders, preferably with particle sizes ranging from 1 μm to 50 μm.

Silicon carbide is a good thermal conductor. It may also serve as a protective layer that resists oxidation and prevents burning. To achieve this, the silicon carbide powder and silicon powder may be provided at the outer part of the mould. In the latter case, silicon carbide would be produced by the reaction of silicon powder with carbon. Upon sintering, the silicon carbide forms a layer on the outer surfaces of the material that protects the composite against oxidation.

In a mixing step S200, the components may be mixed in a mixing chamber for about two hours.

Mixing is followed by green compaction (S300). In this step, the mixture is uniformly distributed in the graphite mould 18a, 18b and cold-pressed at a mechanical pressure of between 10 and 20 MPa by means of the graphite punches 14a, 14b and force actuators 16a, 16b.

After compaction, the hot-pressing begins and the sintering cycle is started (S400).

The hot-pressing step S400 will now be described in further detail with reference to the flow diagram of FIG. 2b.

Initially, a mechanical pressure of between 12 and 18 MPa is applied to the green compound by means of the force actuator 16a, 16b and graphite punches 14a, 14b. A high vacuum (up to 10⁻⁴ mbar) is generated in the vacuum chamber 24, while the temperature in the sintering chamber 12 is gradually increased at a heating rate of around 1° C. per second until a temperature of approximately 500° C. is reached in the sintering chamber 12 (step S402).

At this temperature, the pressure is reduced to 8 to 12 MPa, while the furnace is vented with a gas mixture of N₂ and a small fraction (around 3%) of H₂, increasing the gas pressure to 10⁻¹ to 10⁻² mbar (step 404).

Afterwards, the high vacuum in the range of approximately 10⁻⁴ mbar is re-established. The temperature in the sintering chamber 12 is now increased to approximately 1.000 ° C. at the same heating rate of approximately 1° C. per second, while the mechanical pressure is progressively increased to 25 to 35 MPa by means of the force actuators 16a, 16b and graphite punches 14a, 14b (step S406).

Once a temperature of approximately 1.000° C. is reached, the mechanical pressure is reduced to 8 to 12 MPa, and the sintering furnace 10 is again vented with the gas mixture of N₂ and 3% H₂ (step S408).

Subsequently, the mechanical pressure is increased to 35 to 45 MPa, and the temperature in the sintering chamber 12 is increased to approximately 2.500° C. to 2.600° C. At this stage, liquid phase sintering takes place (step S410).

Once this is attained, temperature and pressure are kept for at least 10 minutes. Finally, in step S412, the temperature in the sintering chamber 12 is slowly decreased to approximately 100° C. while the pressure is maintained at around 35 to 45 MPa, and the sintering cycle ends.

The preferential recrystallization of {1000} graphite planes during the rapid hot pressing at temperatures in the range of 2.500 to 2.600° C. leads to a well-ordered structure in the composite, ensuring high thermal conductivity and superior mechanical properties. The high mobility of carbon atoms favors a solid-state reaction between molybdenum and graphite, which generates Mo₂C.

Returning to FIG. 2b, after the hot-pressing the formed composite is allowed to cool down, and can subsequently be removed from the sintering chamber 12 (step S500).

Optionally, in a subsequent step S600 a molybdenum cladding may be added to the formed composite. One or several faces of the molybdenum carbide/carbon composite previously formed in steps S100 to S500 may be cladded with a molybdenum sheet having a thickness of, for instance, approximately 500 μm. For the molybdenum cladding, the assembly is introduced into the graphite moulds 18a, 18b again and a pressure of 35 to 45 MPa is applied, while the temperature is gradually increased to 1.200 to 1.600° C., again at a heating rate of approximately 1° C. per second. Once the maximum temperature is reached, temperature and pressure are kept for up to 10 minutes. After having cooled down, the cladded composite may be removed from the mould.

The thin cladding of pure molybdenum allows to further enhance the electrical conductivity of the composite from approximately 1 MS/m to approximately 19 MS/m, which is another important advantage of the processing method according to the present invention.

The inventors found that the molybdenum carbide/carbon composites according to the present invention combine exceptional thermal conductivity (in excess of 700 W/m/K), very low density (down to 2.8 kg/dm³), and low thermal expansion (in the range of 3×10⁻⁶ K⁻¹) with the superior electrical conductivity as described above.

This combination of features makes the composite materials according to the present invention ideally suited for applications to beam intercepting devices, such as for collimator jaws. The proposed materials solve one of the main drawbacks of the conventional graphite materials, dramatically reducing the RF impedance by a factor of more than 10. Most of the other key properties of C/C are maintained or even improved. In particular, the thermal conductivity of the composite materials according to the present invention is three to four times larger than that of C/C. This could prove particularly useful to outweigh material degradation due to radiation effects.

However, the composite material and manufacturing method according to the present invention are not limited to applications to beam intercepting devices, but may be used for a large variety of applications in which high service temperatures, thermal shocks, large heat loads and demanding dimensional stability are expected. Examples include thermal management for high-power electronics, aircraft jet engines and gas turbines, braking systems for high-speed vehicles, solar thermal panels or plasma-facing components for fusion reactors.

In thermal management applications for microelectronics, the most widely used material so far for heat sinks is copper, thanks to its high thermal conductivity. However, the continuously growing specific power to be evacuated from CPUs and other electronic devices is difficult to handle even for this material. This imposes limitations on the increase in performance of high-end processors, as excessive head loads may provoke overheating. Additionally, the large mismatch in the coefficients of thermal expansion between copper and semiconductor materials may lead to deformation of the silicon chip, so-called warpage.

The composite materials according to the present invention improve on this due to the high thermal conductivity (80% higher than that of copper), and due to a coefficient of thermal expansion which is much closer to that of semiconductors and their substrates (4−7×10⁻⁶ K⁻¹ as opposed to 17×10⁻⁶ K⁻¹ for copper).

The fuel efficiency and performance of gas turbines and aircraft engines largely depends upon the maximum temperatures that can be continuously sustained by the structural elements of the combustion chamber and of the turbine. Sophisticated materials such as nickel-based superalloys have been developed for these applications to increase the operating temperature, which, however, still cannot exceed 1.200° C.

The new molybdenum carbide/carbon materials according to the present invention, possibly equipped with adequate cladding protecting them from oxidation, could potentially withstand temperatures up to 500 degrees higher than those admissible for superalloys. Hence, they could be used for hot parts exposed to relatively low stresses, such as non-rotating parts in gas turbines and aircraft engines.

Manufacturers of high-end sports cars are more and more frequently replacing the traditionally cast iron or steel braking discs with carbon-ceramics discs, which can contribute to fuel savings as a result of weight reduction, shorter braking distances, better handling and reduced gyroscopic effects. However, these materials are affected by some drawbacks, such as low strength, brittleness, wear and limited thermal conductivity. The molybdenum carbide/carbon composite materials according to the present invention would improve on all of these properties.

Materials for the plasma facing components in nuclear fusion reactors need to withstand extremely harsh environments, due to the very high operating temperatures, large heat fluxes and energetic particle irradiation, particularly by neutrons. Carbon has been the material of choice for many years, but its absorption of tritium makes its use problematic in tritium-fueled reactors. Beryllium and tungsten have been considered as alternatives, the former because of its low atomic number and weak tritium retention, the latter because of its very high melting temperature and low energy threshold for sputtering. However, beryllium has a low melting temperature, can easily be sputtered and is toxic, whereas tungsten is prone to embrittlement under neutron irradiation, is very dense and has limited thermal shock resistance. The molybdenum carbide/carbon composite materials according to the present invention improve on these materials due to their very high thermal conductivity, low atomic number, low coefficient of thermal expansion and high thermal shock resistance.

The description of the preferred embodiments and the drawings merely serve to illustrate the invention, but should not be understood to imply any limitation. The scope of the invention is to be determined solely by means of the appended claims.

### REFERENCE SIGNS

10 sintering apparatus/furnace

12 sintering chamber

14a, 14b graphite punches

16a, 16b force actuators

18a, 18b mould, dies

20 current source

22 cable connections

24 vacuum chamber

1. A composite material, comprising molybdenum carbide, graphite and carbon fibers.

2. The composite material according to claim 1, wherein said carbon fibers are pitch-based fibers.

3. The composite material according to claim 1, wherein at least a part of said carbon fibers are fibers with a length no smaller than 2 mm and/or no greater than 6 mm.

4. The composite material according to claim 1, wherein at least a part of said carbon fibers are fibers with a length no smaller than 0.05 mm and/or no greater than 1 mm, preferably no greater than 0.3 mm.

5. The composite material according to claim 1, wherein said fibers comprise both long fibers and short fibers, wherein said long fibers have a length no shorter than 2 mm and/or no longer than 6 mm, and wherein said short fibers have a length no shorter than 0.05 mm and/or no longer than 1 mm, preferably no longer than 0.3 mm.

6. The composite material according to claim 1, comprising at least 1% by volume of said carbon fibers, preferably at least 10% by volume of said carbon fibers, and particularly at least 20%.

7. The composite material according to claim 1, comprising at most 40% by volume of carbon fibers, and preferably at most 30% by volume.

8. The composite material according to claim 1, further comprising a refractory metal, particularly tungsten.

9. The composite material according to claim 8, comprising at most 10% by volume of tungsten powder, and preferably at most 1.5% by volume.

10. The composite material according to claim 1, further comprising refractory ceramics, particularly silicon carbide.

11. The composite material according to claim 10, comprising at most 10% by volume of silicon carbide, and preferably at most 5% by volume.

12. The composite material according to claim 1, further comprising silicon.

13. The composite material according to claim 12, comprising at most 10% by volume of silicon, and preferably at most 5% by volume.

14. The composite material according to claim 1, comprising an outer layer of refractory ceramics, particularly silicon carbide.

15. The composite material according to claim 1 with an outer layer comprising pure molybdenum.

16. The composite material according to claim 15, wherein said outer layer has a thickness of at least 0.1 mm, preferably at least 0.5 mm.

17. A method for manufacturing a molybdenum carbide/carbon composite, comprising the following steps:
providing a mixture comprising molybdenum powder and graphite particles, in particular natural graphite flakes; and
rapid hot-pressing said mixture;
wherein said hot-pressing comprises a liquid-phase sintering in a sintering furnace (10) at a temperature of at least 2,500° C., preferably at least 2,600° C.

18. The method according to claim 17, wherein said liquid-phase sintering is performed at a pressure of at least 30 MPa, preferably at least 35 MPa, and in particular at least 40 MPa.

19. The method according to claim 17, wherein said hot-pressing comprises a venting step of introducing a reducing gas into said sintering furnace (10), in particular a gas mixture of N₂ and H₂.

20. The method according to claim 17, wherein said hot-pressing comprises alternating steps of venting by introducing a reducing gas into said sintering furnace (10), and evacuating said sintering furnace (10), preferably evacuating said sintering furnace (10) to a pressure of no more than 10⁻² mbar, in particular no more than 10⁻⁴ mbar.

21. The method according to claim 17, wherein said hot-pressing comprises a step of monitoring a temperature in said sintering furnace (10), preferably by means of a pyrometer, and adjusting a heating rate in said sintering furnace (10) in accordance with said monitored temperature.

22. The method according to claim 17, wherein said mixture comprises at least 5% by volume of molybdenum powder, and preferably at least 8% by volume of molybdenum powder.

23. The method according to claim 17, wherein said molybdenum powder has particle sizes no smaller than 1 μm, and/or no larger than 50 μm.

24. The method according to claim 17, wherein said mixture comprises at least 30% by volume of graphite particles, particularly natural graphite flakes, and preferably at least 40% by volume.

25. The method according to claim 17, wherein said natural graphite flakes have a platelet size of at least 20 μm, and/or no more than 400 μm.

26. The method according to claim 17, wherein said mixture comprises carbon fibers, in particular mesophase pitch-based carbon fibers.

27. The method according to claim 17, wherein said mixture comprises refractory metal powder, in particular tungsten powder.

28. The method according to claim 17, wherein said mixture comprises refractory ceramics, in particular silicon carbide powder.

29. The method according to claim 17, wherein said mixture comprises silicon powder.

30. The method according to claim 28, further comprising a step of providing said refractory ceramics, in particular silicon carbide in a boundary region of said mixture.

31. The method according claim 17, comprising a step of cladding said molybdenum carbide/carbon composite with an outer layer comprising pure molybdenum.
